(19) United States
(12) Patent Application Publication
(10) Pub. No.: US 2025/0008423 A1
(43) Pub. Date: Jan. 2, 2025

(54) SYSTEM AND METHOD FOR ALLOWED NETWORK SLICE SELECTION ASSISTANCE INFORMATION HANDLING

(71) Applicant: Verizon Patent and Licensing Inc., Basking Ridge, NJ (US)

(72) Inventors: Helen Osias Eglip, Sammamish, WA (US); Sudhakar Reddy Patil, Flower Mound, TX (US); Samirkumar Patel, Middlesex, NJ (US); Suzann Hua, Beverly Hills, CA (US)

(21) Appl. No.: 18/345,190

(22) Filed: Jun. 30, 2023

(51) Int. Cl. H04W 48/18; H04W 8/18; H04W 60/04

(52) U.S. Cl. CPC H04W 48/18; H04W 8/18; H04W 60/04

(57) ABSTRACT

A system comprises one or more devices that implement a network function. The network function receives a connection request for a User Equipment (UE) device, the connection request including requested Network Slice Selection Assistance Information (NSSAI) for a mobile network. The network function retrieves subscribed NSSAI that includes NSSAI of slices from a subscription associated with the UE device. The network function determines expanded allowed NSSAI based on the subscribed NSSAI and NSSAI supported by the network. The network function sends, to the user device, the expanded allowed NSSAI.

### BACKGROUND INFORMATION

Next Generation mobile networks, such as Fifth Generation (5G) mobile networks, are designed to increase data transfer rates, increase spectral efficiency, improve coverage, improve capacity, and reduce latency. For example, a 5G network may incorporate “network slicing” technology to increase network efficiency and performance.

Network slicing is a type of virtualized networking architecture that involves partitioning of a single physical network into multiple virtual networks. The partitions, or “slices,” of the virtualized network may be customized to meet the specific needs of applications, services, devices, customers, or operators. Each network slice can have its own architecture, provisioning management, and security that supports a particular application or service.

### BRIEF DESCRIPTION OF THE DRAWINGS

FIG. 1 illustrates an overview of systems and methods for enabling immediate use of updated network slice options;

FIG. 2 illustrates an exemplary network environment in which the systems and methods for enabling immediate use of updated network slice options may be implemented, according to an implementation;

FIG. 3 depicts exemplary components of a portion of a network according to an implementation;

FIGS. 4 and 5 illustrate exemplary processing and messaging that are associated with enabling immediate use of updated network slice options, according to various implementations;

FIG. 6 illustrates a flow diagram of a process associated with enabling immediate use of updated network slice options, according to an implementation; and

FIG. 7 depicts exemplary components of an exemplary network device.

### DETAILED DESCRIPTION

The following detailed description refers to the accompanying drawings. The same reference numbers in different drawings may identify the same or similar elements. Also, the following detailed description does not limit the invention.

User equipment devices (UEs) may execute various applications that generate network traffic with different service requirements. These different service requirements may be met through network slicing. A network slice refers to a complete logical network that includes components, of a Radio Access Network (RAN) and core network, which provide certain telecommunication services and network capabilities that can vary from slice to slice. Bandwidth, capacity, and connectivity functions are allocated within each network slice to meet the requirements of the network slices. Selection of network slices for a particular application can thus have significant impact on network performance and user experience.

Many advanced networks today use Network Slice Selection Assistance Information (NSSAI) and Single NSSAI (S-NSSAI) to identify network slices. The NSSAI may provide information that permits selections of a particular network slice, and a corresponding set of network functions (e.g., access and mobility management functions (AMFs)) that may be associated with that particular network slice. Different NSSAIs can be given by the network or requested by UEs. As used herein, the term NSSAI may be used to refer to network slice information or the actual network slice.

Typically, as part of a registration process, an application running on a UE may request an NSSAI that has been previously provisioned for use by the UE, if available. Assuming the requested NSSAI is supported by network and is part of a user's subscription, the network may allow use of the NSSAI by the UE. If the requested NSSAI is not supported by the network or is not part of the user's subscription, the network may provide alternative NSSAI for the UE registration. However, if one or more of the alternative NSSAI that the network provides has not been previously provisioned for use by the UE, the alternative NSSAI will not be used in the current connection request. That is, when a slice is subsequently added to a UE subscription or otherwise becomes available to the UE, the UE may not know that the new slice can be requested until a power cycle or mobility registration is performed.

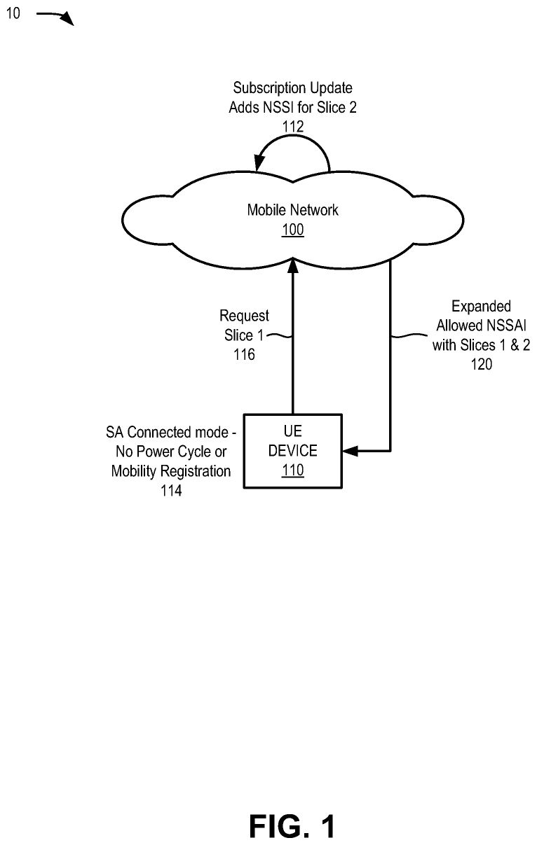

Systems and methods described herein enable immediate use of updated network slice options by UE devices. FIG. 1 illustrates concepts described herein. A system 10 may include a mobile network 100 (e.g., including a core network and RAN) that supports network slicing for a UE 110.

Mobile network 100 (also referred to herein as “network 100”) may include a Public Land Mobile Network (PLMN) and possibly one or more other networks (not shown in FIG. 1) that provides wireless (e.g., Radio Frequency (RF)) communication with UEs 110. Mobile network 100 may be composed of sub-networks, such as a RAN and a core network, as described further herein.

In accordance with 5G network standards, mobile network 100 can provide “Allowed NSSAI,” “Configured NSSAI,” and “Rejected NSSAI,” while the UE 110 can use “Requested NSSAI” to request a network slice. Under the current standards, the Allowed NSSAI can be defined as the intersection of the Requested NSSAI, the Network Supported NSSAI, and the customer's subscribed NSSAI. The Rejected NSSAI can be defined as NSAAI that is included in Requested NSSAI but not supported by the network or not in the subscribed NSSAI. Configured NSSAI may be defined as the subscribed NSSAI.

In FIG. 1, assume mobile network 100 supports a Slice 1 and a Slice 2, and UE 110 has a subscription for Slice 1. A customer (e.g., a user of UE 110) may submit an order to add Slice 2 to the customer subscription. As indicated at reference 112, network 100 may update the customer subscription to add the corresponding NSSAI for Slice 2, which can eventually be communicated to UE 110.

At the time of subscription update 112, UE 110 may be in a connected or idle mode on a 5G Standalone (SA) network, may be on connected or idle mode of Non-Standalone (NSA) network/LTE network, or can be powered off. If UE 110 is in SA connected mode 114 when mobile network 100 pushes the network slice subscription to UE 110, UE 110 would not be aware of the newly provisioned NSSAI for Slice 2. Instead, UE 110 will use NSSAI for Slice 1 in request 116. Under conventional network configurations, mobile network 100 would respond to request 116 by providing Allowed NSSAI for the requested slice (Slice 1, assuming Slice 1 is supported by network 100), even though the customer had recently subscribed to Slice 2.

According to implementations described herein, logic in mobile network 100 is enhanced to respond to request 116 by providing new Expanded Allowed NSSAI 120, which includes NSSAI for both Slice 1 (e.g., the requested slice) and Slice 2 (e.g., the newly subscribed slice). Thus, UE 110 is assured of receiving the NSSAI for a new slice subscription without having to perform a power cycle or make a mobility registration to obtain updated network slice options.

FIG. 1 illustrates a use case (e.g., subscription updates) wherein systems and methods described herein can enable immediate use of new network slice options by UE devices. In other implementations, systems and methods described herein can be applied to provide immediate access to NSSAI for configuration update commands for either RAN or AMF Slice support changes. Additionally, the systems and methods may be applicable to registration accept messages on an initial or mobility registration case.

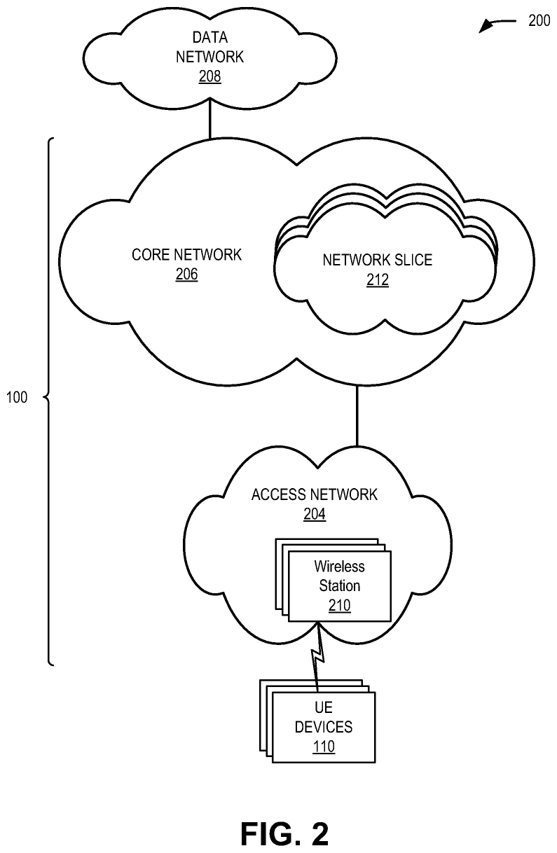

FIG. 2 illustrates an exemplary network environment 200 in which system 10 of FIG. 1 may be implemented. As shown, network environment 200 may include a UE 110, an access network 204, a core network 206, and a data network 208. Access network 204 and a core network 206 may be part of mobile network 100.

UE 110 may include a wireless computational communication device. Examples of UE 110 include: a smart phone; a tablet device; a wearable computer device (e.g., a smart watch); a global positioning system (GPS) device; a laptop computer; a media playing device; a portable gaming system; an autonomous vehicle navigation system; a sensor, such as a pressure sensor or; and an Internet-of-Things (IoT) device. In some implementations, UE 110 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices.

Access network 204 may allow UE 110 to access core network 206. To do so, access network 204 may establish and maintain, with participation from UE 110, an over-the-air channel with UE 110; and maintain backhaul channels with core network 206. Access network 204 may relay information through these channels, from UE 110 to core network 206 and vice versa. Access network 204 may include a Long-term Evolution (LTE) radio network and/or a Fifth Generation (5G) radio network or other advanced radio network. These networks may include many central units (CUs), distributed units (DUs), radio units (RUS), and wireless stations, one of which is illustrated in FIG. 2 as wireless station 210 for establishing and maintaining over-the-air channel with UE 110. Wireless station 210 may include a 4G, 5G, or another type of base station (e.g., eNB, gNB, etc.) that comprise one or more radio frequency (RF) transceivers. In some implementations, wireless station 210 may be part of an evolved Universal Mobile Telecommunications Service (UMTS) Terrestrial Network (eUTRAN).

Core network 206 may manage communication sessions of subscribers connecting to core network 206 via access network 204. For example, core network 206 may establish an Internet Protocol (IP) connection between UEs 110 and data network 208. In some implementations, core network 206 may include a 5G core network. In other implementations, core network 206 may include a 4G core network (e.g., an evolved packet core (EPC) network) in combination with a 5G network or another type of core network.

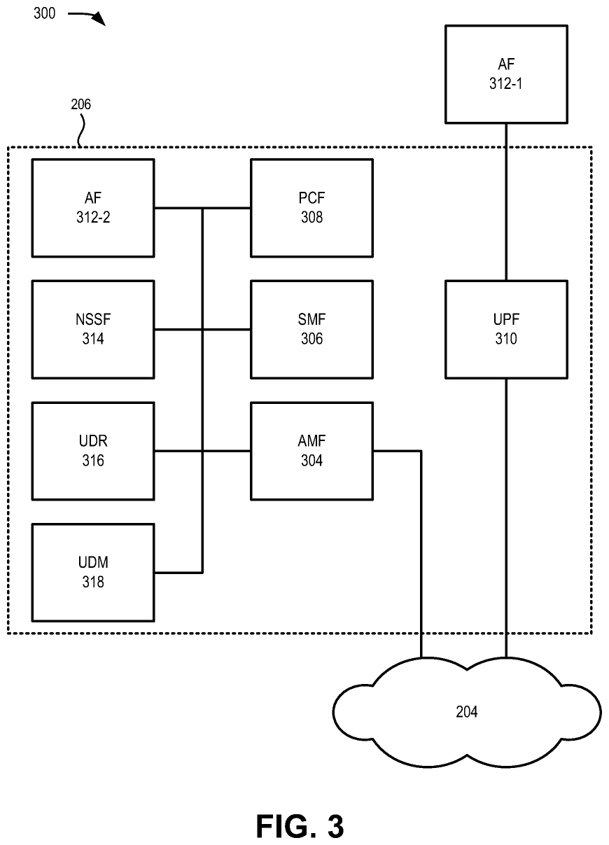

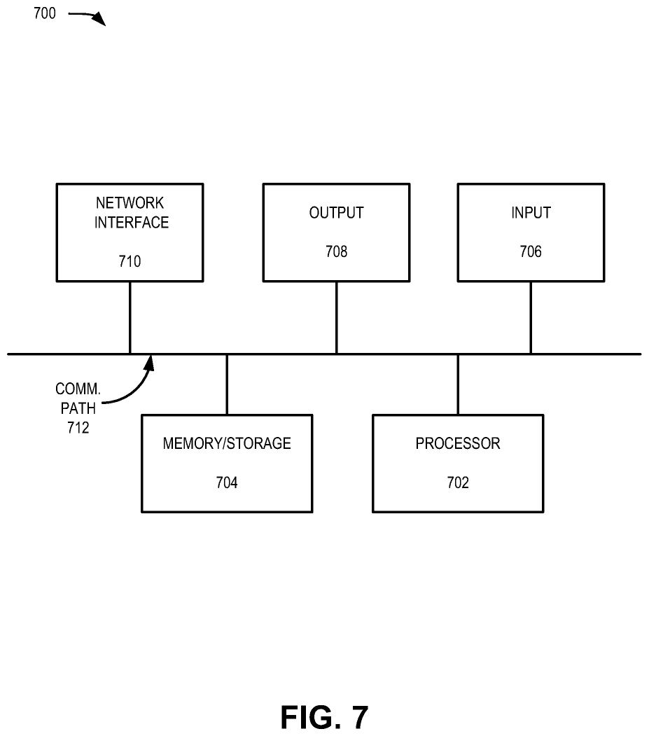

The components of core network 206 may be implemented as dedicated hardware components or as virtualized functions implemented on top of a common shared physical infrastructure using Software Defined Networking (SDN). For example, an SDN controller may implement one or more of the components of core network 206 using an adapter implementing a Virtual Network Function (VNF) virtual machine, a container, an event driven server-less architecture interface, and/or another type of SDN component. The common shared physical infrastructure may be implemented using one or more devices 700 described below with reference to FIG. 7 in a cloud computing center associated with core network 206. Exemplary components of core network 206 are described below with reference to FIG. 3.

Data network 208 may include one or more networks connected to core network 206. In some implementations, a particular data network 208 may be associated with a data network name (DNN) in 5G, and/or an Access Point Name (APN) in 4G, and a UE 110 may request a connection to data network 208 using a DNN or APN. Data network 208 may include, and/or be connected to and enable communication with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also simply referred to as application). An application may provide services for a program or an application running on UE 110 and may establish communication session with UE 110 via core network 206.

As shown, core network 206 may include one or more network slices 212. Depending on the implementation, network slices 212, may be implemented within other networks, such as access network 204 and/or data network 208. Access network 204, core network 206, and data network 208 may include multiple instances of network slices 212. Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport, Central Processing Unit (CPU) cycles, memory, etc. Furthermore, each network slice may be configured to meet a different set of requirements and be associated with a particular Quality of Service (QOS) class, a type of service, and/or a particular group of enterprise customers associated with communication devices.

Each network slice 212 may be associated with an identifier, herein referred to as a Single Network Slice Selection Assistance Information (S-NSSAI). For each UE 110 that wishes to access a particular network slice, the subscription data for the UE 110 (stored in core network 206, for example) may include the S-NSSAI corresponding to the network slice.

Depending on the implementation, network environment 200 may include additional networks and components than those illustrated in FIG. 2. However, for clarity, FIG. 2 does not show all components that may be included in network environment 200 (e.g., routers, bridges, wireless access point, additional UE devices, switches, etc.).

FIG. 3 depicts exemplary components of a portion 300 of network environment 200 according to an implementation. As shown, portion 300 may include access network 204, an application function (AF) 312-1, and a portion of core network 206. Access network 204 has been described above with reference to FIG. 2. AF 312-1 is one of what have been referred to as NFs (network functions). AF 312-1 may provide an application function that belongs to a third party (i.e., an entity different from a service provider) and provides services to UEs 110 via access network 204, core network 206, and/or data network 208.

In FIG. 3, core network 206 comprises, in addition to other components described with reference to FIG. 2, multiple NFs that are implemented in accordance with Service Based Architecture (SBA), either as hardware devices or virtual components (e.g., a container or a virtual machine). Each NF includes a particular set of network functionalities and may act as a consumer NF (an NF that receives services from an NF) or a producer NF (an NF that provides services to consumer NFs).

As shown, core network 206 includes: an Access and Mobility Management Function (AMF) 304, a Session Management Function (SMF) 306, a Policy Control Function (PCF) 308, a User Plane Function (UPF) 310, an AF (Application Function) 312-2, a Network Slice Selection Function (NSSF) 314, a Unified Data Repository (UDR) 316, and a Unified Data Management (UDM) 318. Depending on the implementation, core network 206 may include additional, fewer, or different components than those illustrated in FIG. 3.

AMF 304 may perform registration management, connection management, reachability management, mobility management, lawful intercepts, Short Message Service (SMS) transport between UE 110 and an SMS function, session management message transport between UE 110 and SMF 306, access authentication and authorization, location services management, support of non-3GPP access networks, and/or other types of management processes. AMF 304 may page UE 110 based on mobility category information associated with UE 110 obtained from UDM 318. In some implementations, AMF 304 may implement some or all of the functionality of managing RAN slices in wireless station 210.

SMF 306 may perform session establishment, modification and/or release; perform IP address allocation and management; perform Dynamic Host Configuration Protocol (DHCP) functions; perform selection and control of UPF 310; configure traffic steering at UPF 310 to guide traffic to the correct destination; terminate interfaces toward PCF 308; perform lawful intercepts; charge data collection; support charging interfaces; control and coordinate charging data collection; terminate session management parts of Non-Access Stratum (NAS) messages; perform downlink data notification; manage roaming functionality; and/or perform other types of control plane processes for managing user plane data.

PCF 308 may support policies to control network behavior, provide policy rules to control plane functions (e.g., to SMF 306), access subscription information relevant to policy decisions, perform policy decisions, and/or perform other types of processes associated with policy enforcement.

UPF 310 may maintain an anchor point for intra/inter-radio access technology (RAT) mobility (e.g., mobility across different radio access technologies; maintain an external Packet Data Unit (PDU) point of interconnect to a data network (e.g., an IP network, etc.); perform packet routing and forwarding; perform the user plane part of policy rule enforcement; perform packet inspection; perform lawful intercept; perform traffic usage reporting; perform Qos handling in the user plane; perform uplink traffic verification; perform transport level packet marking; perform downlink packet buffering; send and forwarding an “end marker” to a RAN node (e.g., wireless station 210); and/or perform other types of user plane processes.

AF 312-2 may provide services associated with a particular application, such as, for example, application on traffic routing, accessing a Network Exposure Function (NEF) (not shown), interacting with a policy framework for policy control, and/or other types of applications. In contrast to AF 312-1, AF 312-2 may reside within core network 206 and/or access network 204.

NSSF 314 may select a set of network slice instances to serve a particular UE 110, determine NSSAI or an S-NSSAI, determine a particular AMF 304 to serve a particular UE 110, and/or perform other types of processes associated with network slice selection or management. In some implementations, NSSF 314 may receive network slice-related information from a Network Slice Management Function (NSMF) (not shown) that manages network slices. The management may include instantiation, removal, and/or modification of network slices based on specifications. When an NSMF creates a network slice, the NSMF may obtain an S-NSSAI for the network slice and store the S-NSSAI via NSSF 314.

UDR 316 may store subscriber data (e.g., subscriber profile) associated with UEs 110, modify subscriber data, and/or delete subscriber data. UDM 318 may maintain subscription information for UE 110; manage subscriptions; generate authentication credentials; handle user identification; perform access authorization based on subscription data; perform network function registration management; maintain service and/or session continuity by maintaining assignment of SMF 306 for ongoing sessions; support SMS delivery, support lawful intercept functionality; and/or perform other processes associated with managing user data. For example, UDM 318 may store subscription profiles that include authentication, access, and/or authorization information. Each subscription profile may include information identifying UE 110; authentication and/or authorization information for UE 110; information identifying services enabled and/or authorized for UE 110; device group membership information for UE 110; and/or other types of information associated with UE 110. Furthermore, the subscription profile may include mobility category information associated with UE 110.

Depending on the implementation, core network 206 may include additional, fewer, and/or different components than those illustrated in FIG. 3. Furthermore, depending on the implementation, in addition to the functionalities described above, the components 302-320 may include additional capabilities. Such capabilities may be implemented through modification of standard interfaces and/or addition of new interfaces for interacting with various network functions.

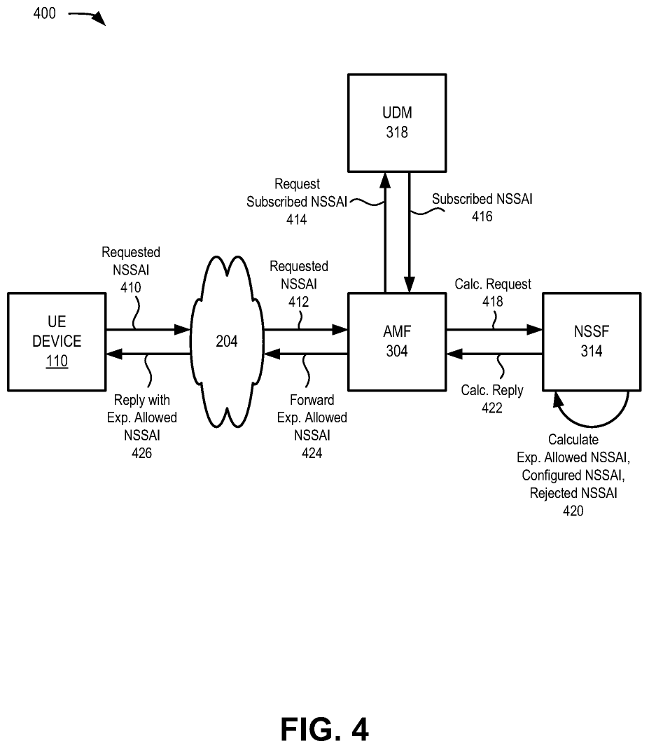

FIG. 4 illustrates exemplary processing and messaging in a portion 400 of network environment 200 to enable immediate use of new network slice subscriptions by UEs 110, according to an implementation. Network portion 400 may include UE 110, access network 204, AMF 304, NSSF 314, and UDM 318. In the example of FIG. 4, assume that a subscription for UE 110 has been updated in UDM 318 to include NSSAI of a new network slice since the last time UE 110 was restarted or had a mobility registration.

As shown in FIG. 4, UE 110 may send a connection request 410. Connection request 410 may include an S-NSSAI and/or a network slice instance identifier (ID). Since UE 110 is unaware of the subscription update at UDM 318, the S-NSSAI and/or the network slice instance ID (collectively referred to herein as “Requested NSSAI”) may identify a network slice to which UE 110 expects to connect (e.g., based on previously-allowed NSSAI prior to the subscription update). Alternatively, connection request may not include Requested NSSAI (e.g., if no preferred slice is known by UE 110).

Request 410 is sent to access network 204 (or to a wireless station, such as a gNB, in access network 204). Access network 204 forwards a message 412 to AMF 304, conveying UE 110's connection request. As such, message 412 carries the Requested NSSAI of the network slice to which UE 110 seeks to connect. Upon receipt of message 412, AMF 304 may proceed to access UDM 318, for obtaining information in the user subscription profile at UDM 318. Accordingly, AMF 304 sends a request message 414 to UDM 318 and obtains a reply 416 that includes subscribed NSSAI for UE 110. The subscribed NSSAI identifies the network slices which UE 110 is allowed to access or connect, including NSSAI for the newly subscribed slice.

AMF 304 may receive reply 416 with the subscribed NSSAI. AMF 304 may send a message 418 to NSSF 314 with the subscribed slice information (from response 416) requesting NSSF 314 to identify other or all network slices that UE 110 may access. In response to message 418, NSSF 314 may perform calculations 420 to determine the Expanded Allowed NSSAI, the Configured NSSAI, and/or Rejected NSSAI. While the Configured NSSAI and the Rejected NSSAI may be determined using known approaches, the Expanded Allowed NSSAI may be determined without taking into consideration the Requested NSSAI (from messages 410/412). Instead, NSSF 314 may consider what mobile network 100 (e.g., access network 204 and core network 206) can support and what UE 110 is subscribed to. For example, NSSF 314 may calculate the Expanded Allowed NSSAI as the intersection of the RAN Supported NSSAI, the Core supported NSSAI, and the subscribed NSSAI.

After performing calculations 420, and in response to message 418, NSSF 314 may send to AMF 304 a reply 422, which includes the Expanded Allowed NSSAI, the Configured NSSAI, and/or Rejected NSSAI. More specifically, NSSF 314 may provide in reply 422 Expanded Allowed NSSAI that includes the Requested NSSAI (assuming the Requested NSSAI contains NSSAI that is valid in the serving PLMN) and any other NSSAI that the UE is subscribed to and supported by mobile network 100. Reply 422 may also include Configured NSSAI (which would include all subscribed NSSAI for the UE 110) and Rejected NSSAI (which would include the requested NSSAI if the Requested NSSAI is not supported by mobile network 100 or not in the subscribed NSSAI).

AMF 304 may send, in its reply 424 to message 412 from access network 204, the Expanded Allowed NSSAI, the Configured NSSAI, and/or Rejected NSSAI received from NSSF 314 in reply 422. Access network 204 may then relay the Expanded Allowed NSSAI, the Configured NSSAI, and/or Rejected NSSAI to UE 110 in its response 426 to the connection request. UE 110 may apply the Expanded Allowed NSSAI immediately to implement a connection using the newly subscribed slice. Thus, by NSSF 314/AMF 304 providing Expanded Allowed NSSAI that includes NSSAI for the newly subscribed slice, additional signaling needed for re-registration to connect to the new slice is avoided.

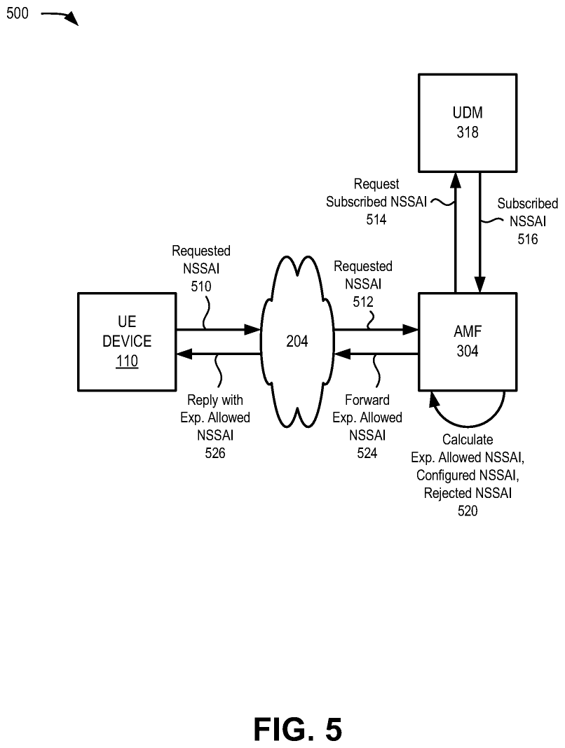

FIG. 5 illustrates exemplary processing and messaging in a portion 500 of network environment 200 to enable immediate use of new network slice subscriptions by UEs, according to an implementation. In contrast to FIG. 4, the processing in messing in FIG. 5 do not include AMF 304 directly interacting with an NSSF. As shown, network portion 500 may include UE 110, access network 204, AMF 304, and UDM 318. Some functions of NSSF 314 described above may be combined in AMF 304. Similar to the example of FIG. 4, in the example of FIG. 5, assume that a subscription for UE 110 has been updated in UDM 318 to include NSSAI of a new network slice since the last time UE 110 was restarted or had a mobility registration.

As shown in FIG. 5, UE 110 may send a connection request 510. Connection request 510 may include Requested NSSAI that identifies a network slice to which UE 110 expects to connect (e.g., based on previously-allowed NSSAI prior to the subscription update). Request 510 may be sent to access network 204, and access network 204 may forward a message 512 to AMF 304, conveying UE 110's connection request. As such, message 512 carries the Requested NSSAI of the network slice to which UE 110 seeks to connect. Upon receipt of message 512, AMF 304 may proceed to establish a connection for checking the user subscription profile at UDM 318. Accordingly, AMF 304 may send a request message 514 to UDM 318 and may obtain a reply 516 that includes subscribed NSSAI for UE 110. The subscribed NSSAI may identify the network slices which UE 110 is allowed to access or connect, including NSSAI for the newly subscribed slice.

AMF 304 may receive reply 516 with the subscribed NSSAI. In response to message 516, AMF 304 may perform calculations 520 to determine the Expanded Allowed NSSAI, the Configured NSSAI, and/or Rejected NSSAI. The Expanded Allowed NSSAI may be determined without taking into consideration the Requested NSSAI (from messages 510/512). AMF 304 may consider what network slices mobile network 100 can support and what UE 110 is subscribed to, without considering the Requested NSSAI. For example, AMF 304 may calculate the Expanded Allowed NSSAI as the intersection of the RAN Supported NSSAI, the Core supported NSSAI, and the subscribed NSSAI.

After performing calculations 520, and in response to message 512, AMF 304 may send a reply 524, which includes the Expanded Allowed NSSAI, the Configured NSSAI, and/or Rejected NSSAI. More specifically, AMF 304 may provide in reply 524 Expanded Allowed NSSAI that includes the Requested NSSAI (assuming the Requested NSSAI contains NSSAI that is valid in the serving PLMN) and any other NSSAI that the UE is subscribed to and supported by mobile network 100. In some implementations, reply 524 may also include Configured NSSAI and Rejected NSSAI. AMF 304 may send reply 524 to access network 204 (e.g., a gNB or other wireless station 210), which may then relay the Expanded Allowed NSSAI, the Configured NSSAI, and/or Rejected NSSAI to UE 110 in its response 526 to connection request 510. UE 110 may apply the Expanded Allowed NSSAI immediately to implement a connection using the newly subscribed slice. Thus, by NSSF 314/AMF 304 providing Expanded Allowed NSSAI that includes NSSAI for the newly subscribed slice, additional signaling of re-registration to connect to the new slice is avoided.

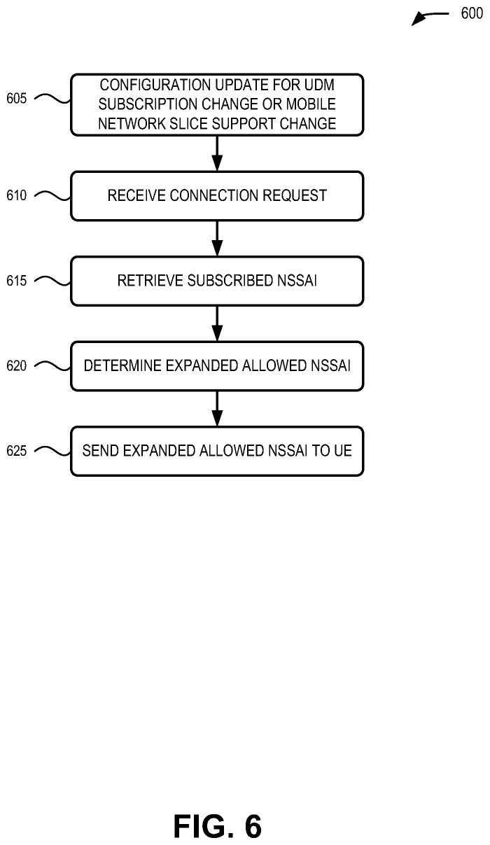

FIG. 6 is a flow diagram of a process 600 associated with enabling immediate use of new network slice subscriptions by UE devices, according to an implementation. Process 600 may be performed by one or more network components, such as those shown FIGS. 1-5. As shown, process 600 may include receiving a configuration update for a UDM subscription change or a mobility network slice support change (605). For example, in one implementation, a user profile in UDM 318 may be updated to reflect a new subscription. In another implementation, a configuration change to access network 204 or AMF 304 may be implemented to support a new network slice.

Process 600 may further include receiving a connection request (block 610) and retrieving subscribed NSSAI (block 615). For example, AMF 304 may receive a connection request from UE 110 that includes a Requested NSSAI and, in response, retrieve from UDM 318 subscribed NSSAI for UE 110.

Process 600 may also include determining expanded allowed NSSAI (block 620) and sending the expanded allowed NSSAI to the UE (block 625). For example, AMF 304 and/or NSSF 314 may perform calculations 520 to determine the Expanded Allowed NSSAI, the Configured NSSAI, and/or Rejected NSSAI. The calculations may be based on (a) what slices UE 110 is subscribed to (e.g., including any recent subscription additions) and (b) what slices access network 204 and core network 206 can support (e.g., including any recent configuration changes). The Expanded Allowed NSSAI may be determined without taking into consideration the Requested NSSAI. AMF 304 may perform the necessary calculations and/or receive the calculated Expanded Allowed NSSAI, the Configured NSSAI, and/or Rejected NSSAI from NSSF 314. AMF 304 may provide the Expanded Allowed NSSAI, the Configured NSSAI, and/or Rejected NSSAI to UE 110 in response to the connection request.

FIG. 7 depicts exemplary components of an exemplary network device 700. Network device 700 may correspond to or be included in any of the devices and/or components illustrated in FIGS. 1-6 (e.g., UE 110, access network 204, core network 206, data network 208, NFs 304-318, etc.). In some implementations, network devices 700 may be part of a hardware network layer on top of which other network layers and NFs may be implemented.

As shown, network device 700 may include a processor 702, memory/storage 704, input component 706, output component 708, network interface 708, and communication path 712. In different implementations, network device 700 may include additional, fewer, different, or different arrangement of components than the ones illustrated in FIG. 7. For example, network device 700 may include line cards, switch fabrics, modems, etc.

Processor 702 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 700 and/or executing programs/instructions.

Memory/storage 704 may include static memory, such as read only memory (ROM), and/or dynamic memory, such as random access memory (RAM), or onboard cache, for storing data and machine-readable instructions (e.g., programs, scripts, etc.). Memory/storage 704 may also include an optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 704 may be external to and/or removable from network device 700. Memory/storage 704 may include, for example, a Universal Serial Bus (USB) memory stick, a dongle, a hard disk, off-line storage, a Blu-Ray® disk (BD), etc. Memory/storage 704 may also include devices that can function both as a RAM-like component or persistent storage, such as Intel® Optane memories.

Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 706 and output component 708 may provide input and output from/to a user to/from network device 700. Input/output components 706 and 708 may include a display screen, a keyboard, a mouse, a speaker, a microphone, a camera, a DVD reader, USB lines, and/or other types of components for obtaining, from physical events or phenomena, to and/or from signals that pertain to network device 700.

Network interface 710 may include a transceiver (e.g., a transmitter and a receiver) for network device 710 to communicate with other devices and/or systems. For example, via network interface 710, network device 700 may communicate over a network, such as the Internet, an intranet, cellular, a terrestrial wireless network (e.g., a WLAN, Wi-Fi, WiMax, etc.), a satellite-based network, optical network, etc. Network interface 710 may include a modem, an Ethernet interface to a LAN, and/or an interface/connection for connecting network device 700 to other devices (e.g., a Bluetooth interface).

Communication path or bus 712 may provide an interface through which components of network device 700 can communicate with one another.

Network device 700 may perform the operations described herein in response to processor 702 executing software instructions stored in a non-transient computer-readable medium, such as memory/storage 704. The software instructions may be read into memory/storage 704 from another computer-readable medium or from another device via network interface 710. The software instructions stored in memory/storage 704, when executed by processor 702, may cause processor 702 to perform one or more of the processes that are described herein.

According to the description above, a system may comprise one or more device 700 that implement a network function. The network function receives a connection request for a UE, the connection request including requested NSSAI for a mobile network. The network function retrieves subscribed NSSAI that includes NSSAI of slices from a subscription associated with the UE device. The network function calculates expanded allowed NSSAI based on the subscribed NSSAI and NSSAI supported by the network. The network function sends, to the UE, the expanded allowed NSSAI.

By providing Expanded Allowed NSSAI, the systems and methods described herein enable immediate use of updated network slice options by UE devices without requiring a mobility registration or UE power cycling. In contrast, conventional signaling uses a re-registration message that requires UE devices to have to disconnect and then re-establish all active PDU sessions. Thus, the systems and methods described herein provide a significant reduction in signaling, for both the RAN network and core network, to enable use of updated network slice options by UEs.

The foregoing description of implementations provides illustration, but is not intended to be exhaustive or to limit the invention to the precise form disclosed. Modifications and variations are possible in light of the above teachings or may be acquired from practice of the invention. Also, while a series of blocks have been described with regard to FIG. 6 the order of the blocks and message/operation flows may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A network device comprising:
a processor configured to:
receive a connection request for a User Equipment (UE) device, the connection request including requested Network Slice Selection Assistance Information (NSSAI) for a mobile network;
retrieve subscribed NSSAI, wherein the subscribed NSSAI includes NSSAI of slices from a subscription associated with the UE device;
determine expanded allowed NSSAI based on the subscribed NSSAI and the NSSAI supported by the mobile network; and
send, to the UE device, the expanded allowed NSSAI.

2. The network device of claim 1, wherein the expanded allowed NSSAI is determined without taking into consideration the Requested NSSAI.

3. The network device of claim 1, wherein the expanded allowed NSSAI includes single NSSAI (S-NSSAI) of a network slice that was subscribed to after a most-recent power cycle or mobility registration by the UE device.

4. The network device of claim 1, wherein when retrieving the subscribed NSSAI, the processor is further configured to:
retrieve the subscribed NSSAI from a subscription profile, which is associated with the UE device, via a Unified Data Management (UDM) component.

5. The network device of claim 1, wherein the NSSAI supported by the mobile network includes NSSAI supported by both an access network and a core network of the mobile network.

6. The network device of claim 1, wherein the network device includes an access and mobility management function (AMF).

7. The network device of claim 1, wherein when, determining the expanded allowed NSSAI, the processor is configured to:
obtain the expanded allowed NSSAI from a network slice selection function (NSSF).

8. The network device of claim 1, wherein the expanded allowed NSSAI includes NSSAI for multiple network slices.

9. A method comprising:
receiving, by a network function for a mobile network, a connection request for a User Equipment (UE) device, the connection request including requested Network Slice Selection Assistance Information (NSSAI) for the mobile network;
retrieving, by the network function, subscribed NSSAI, wherein the subscribed NSSAI includes NSSAI of slices from a subscription associated with the UE device;
determining, by the network function, expanded allowed NSSAI based on the subscribed NSSAI and the NSSAI supported by the mobile network; and
sending, by the network function and to the UE device, the expanded allowed NSSAI.

10. The method of claim 9, wherein the NSSAI supported by the mobile network includes NSSAI supported by both an access network and a core network of the mobile network.

11. The method of claim 9, wherein the expanded allowed NSSAI includes S-NSSAI of a network slice that was subscribed to after a most-recent power cycle or mobility registration by the UE device.

12. The method of claim 9, wherein retrieving the subscribed NSSAI further comprises:
retrieving the subscribed NSSAI from a subscription profile, which is associated with the UE device, via a Unified Data Management (UDM) component.

13. The method of claim 9, wherein the expanded allowed NSSAI is determined without taking into consideration the Requested NSSAI.

14. The method of claim 9, wherein the network function includes an access and mobility management function (AMF).

15. The method of claim 9, wherein determining the expanded allowed NSSAI includes:
obtaining the expanded allowed NSSAI from a network slice selection function (NSSF).

16. The method of claim 9, wherein the expanded allowed NSSAI includes the requested NSSAI and NSSAI for at least one additional network slice.

17. A non-transitory computer-readable medium containing instructions executable by at least one processor, the non-transitory computer-readable medium comprising one or more instructions for:
receiving, by a network function for a mobile network, a connection request for a User Equipment (UE) device, the connection request including requested Network Slice Selection Assistance Information (NSSAI) for the mobile network;
retrieving, by the network function, subscribed NSSAI, wherein the subscribed NSSAI includes NSSAI of slices from a subscription associated with the UE device;
calculating, by the network function, expanded allowed NSSAI based on the subscribed NSSAI and the NSSAI supported by the mobile network; and
sending, by the network function and to the UE device, the expanded allowed NSSAI.

18. The non-transitory computer-readable medium of claim 17, wherein the network function includes a combined an access and mobility management function (AMF) and network slice selection function (NSSF).

19. The non-transitory computer-readable medium of claim 17, wherein the expanded allowed NSSAI includes NSSAI of a network slice that was added to the subscription after a most-recent power cycle or mobility registration by the UE device.

20. The non-transitory computer-readable medium of claim 17, wherein the expanded allowed NSSAI includes S-NSSAI of a network slice that was configured on the access network or the network function after a most-recent power cycle or mobility registration by the UE device.
